(19) United States
(12) Patent Application Publication
(10) Pub. No.: US 2009/0259480 A1
(43) Pub. Date: Oct. 15, 2009

(54) PT Prophetess Theresa Jewelry Collection and Fashion

(76) Inventor: Theresa Teverbaugh, South Holland, IL (US)

Correspondence Address: Prophetess Theresa Teverbaugh, 16902 Manor Drive, South Holland, IL, 60473, US

(21) Appl. No.: 11/947,808

(22) Filed: Apr. 14, 2008

(51) Int. Cl. G06Q 30/00

(52) U.S. Cl. 705/1

(57) ABSTRACT

Articles of Jewelry having colored precious stones designed, priced, and sold at retail locations. The articles of jewelry may be imaged and priced according to a consumer's input on the length at the retail locations having a commitment to purchase the article of jewelry based on the image provided and selected. The goal is to meet the needs of the customers through high quality jewelry at affordable prices challenging competitors by showcasing the industry through an outstanding example of excellent, ethics, and professionalism in all business endeavors. Together, we will work to make the dreams of everyone associated with Prophetess Theresa Jewelry Collection walk in their purpose in style.

### BACKGROUND

It is important for us as the body of Christ to understood the importance of building relationships to enrich are own lives and grow personally as well as to help others understand their God given worth and purpose and looking and feeling good is among them! In the process of bringing women together to further enhance and share whom we based on our unique nature and in the light of God's word, our response to uniformity of products, colors and stones are actually much more complex than most people realize. Colors are a mixture of instinct, cultural conditioning and the result of personal experiences and associations. Semi-Precious Stones have mystical and healing properties.

Blue stones induce calm, peace, creativity, and serenity in wearer. It helps to clarity of mental thought, inspiration and helps with meditation. Yellow stones draw attention to the wearer and build self-esteem and confidence. Orange stones are flamboyant it is linked with creativity, energy and sexual attractiveness. Red stones are associated with excitement, energy, and passion. It bold fiery and linked with courage. Green stones are soothing and calming to wear. It is associated with fertility and wealth. Purple is associated with royalty, power, wealth, spirituality, creativity and insight. Black stones are said to protect the emotions of the wearer from being displayed, allowing the wear to remain mysterious. Aqua/Turquoise stones are loved for their associations with coolness and cleanliness of pure water. The blue green stones promote feelings of tranquility and help with meditation as well as inspiring creativity in the wearer. Pink stones represent friendship, love, and trust. It helps with feelings of anger and isolation. White and clear stones represent purity, truth, and serves as protective stones. They make beautiful gifts to celebrate loving landmarks in people's lives such as engagements, weddings, and anniversaries. Brown stones promote wisdom, health, gravitas, and stability in the wearer.

Onyx stones help ground negativity and release stress and tension.

Pearls symbol of innocence and purity and have a strong feminine association through their similarity to the shape and color of a full moon. Pearls are said to reduce stress and anxiety, high blood pressure and headaches.

Silver is linked to the moon, femininity, creativeness, emotional intelligence, self-awareness, insight, truth, and wisdom.

### BRIEF DESCRIPTION OF THE DRAWINGS

FIG. 1 illustrates a uniquely designed semi precious stone necklace (A) and earrings (B) set designed with black, silver, clear, and purple beads and stones; this set is entitled Evidence of Love.

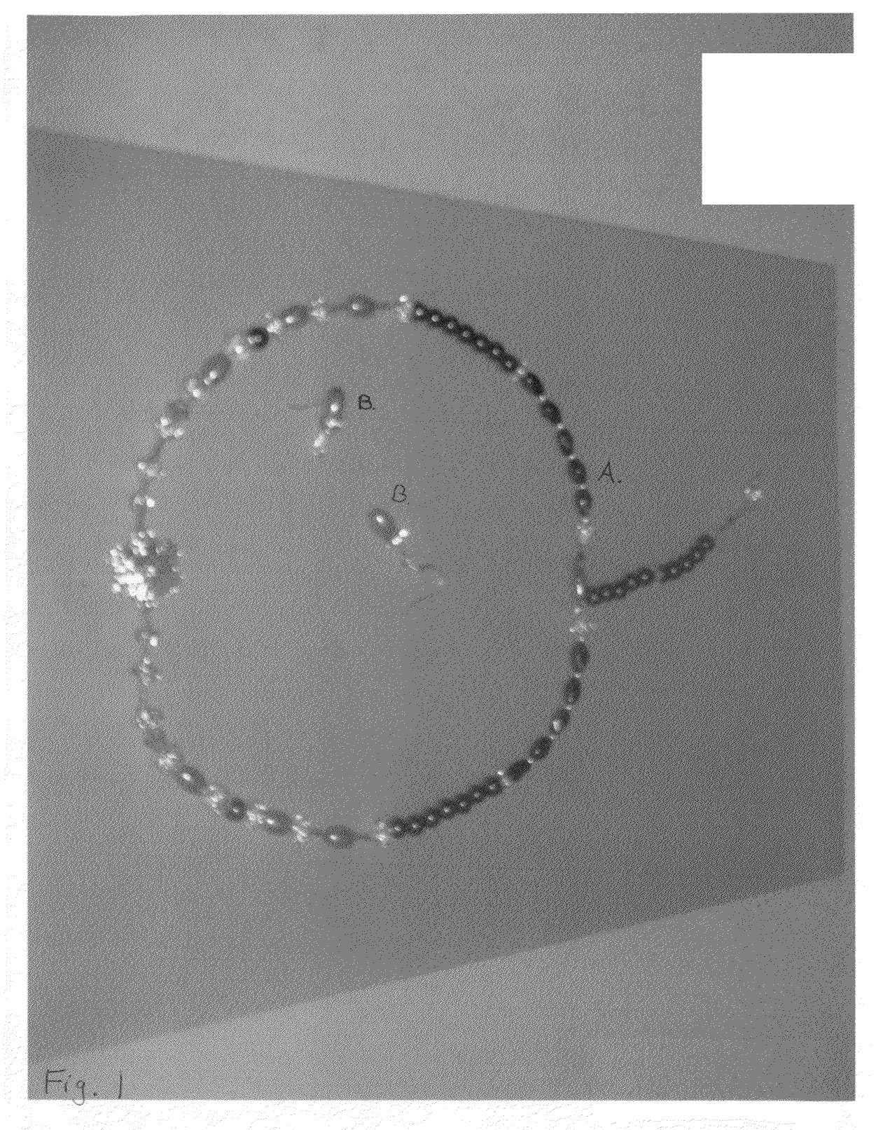

FIG. 2 illustrates a uniquely designed semi precious stone necklace (A) and earrings (B) in white pearls, silver beads, and pink and black stone; this set is entitled Born Again.

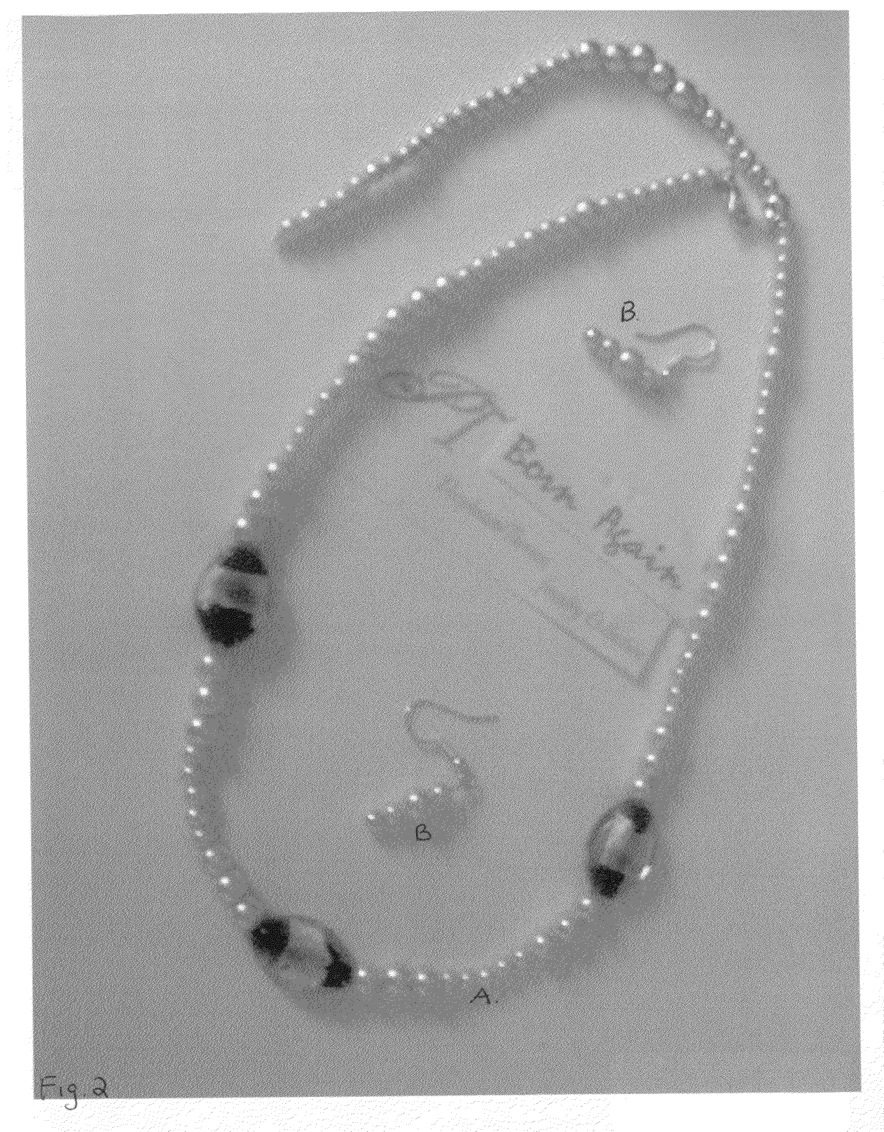

FIG. 3 illustrates a uniquely designed semi precious stone necklace (A) and earrings (B) in red, silver, black, and clear stones and beads; this set is entitled Kenya.

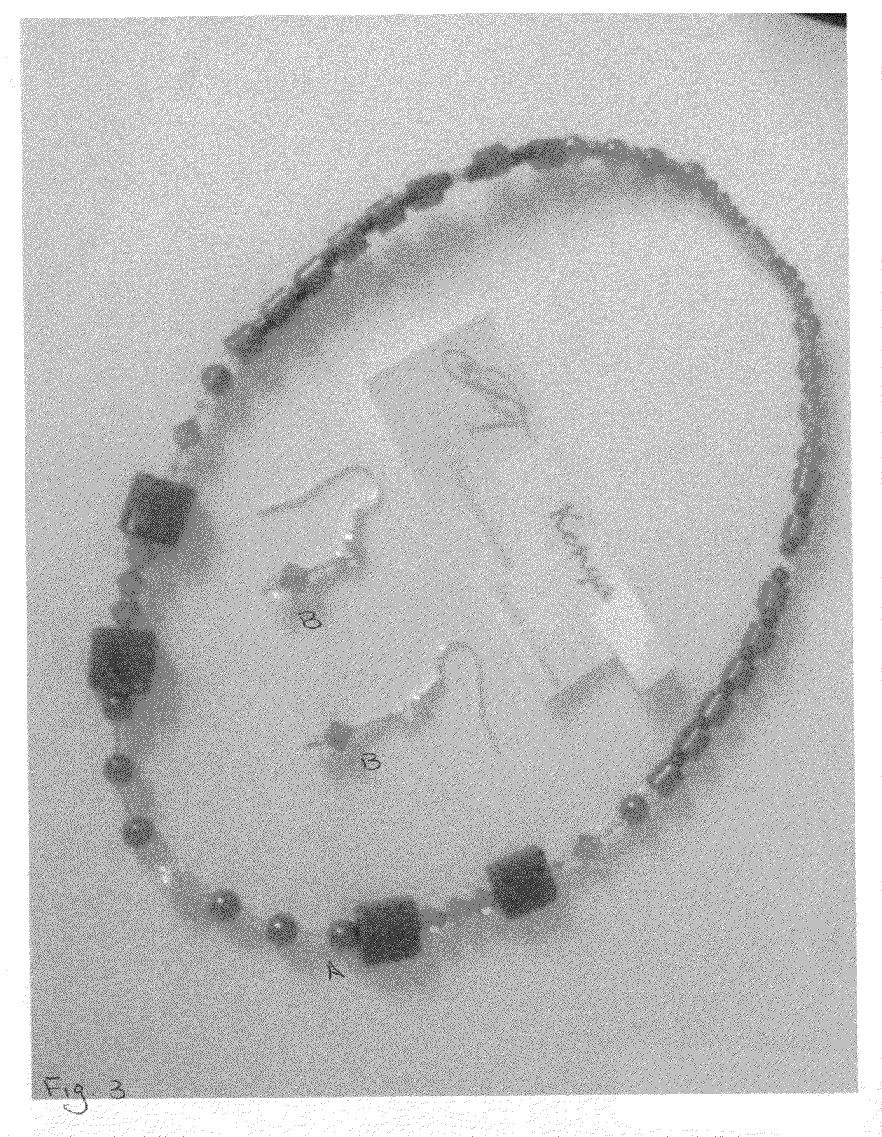

FIG. 4 illustrates a uniquely designed semi precious stone necklace (A) and earrings (B) in aqua and white beads; this set is entitled Simply Pearls.

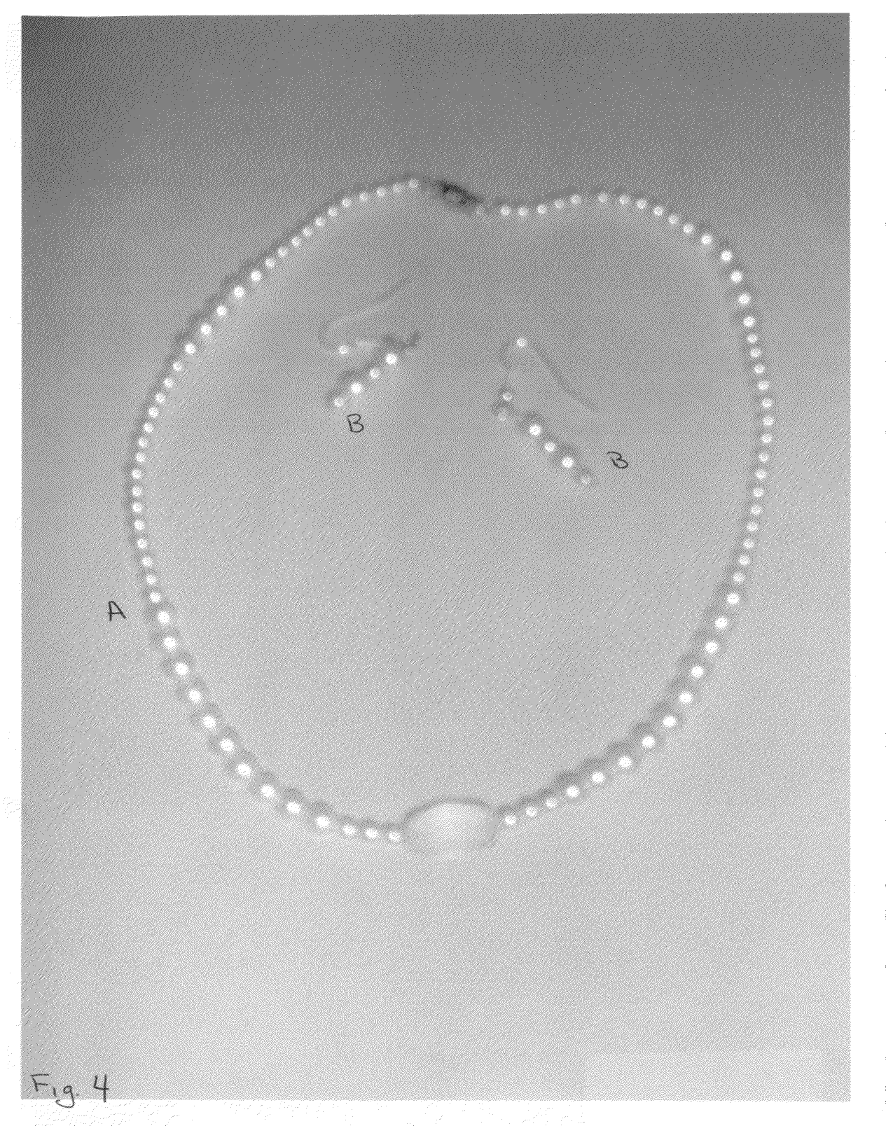

FIG. 5 illustrates a uniquely designed semi precious stone necklace (A) and earrings (B) in white, silver and clear stones and beads; this set is entitled Holy.

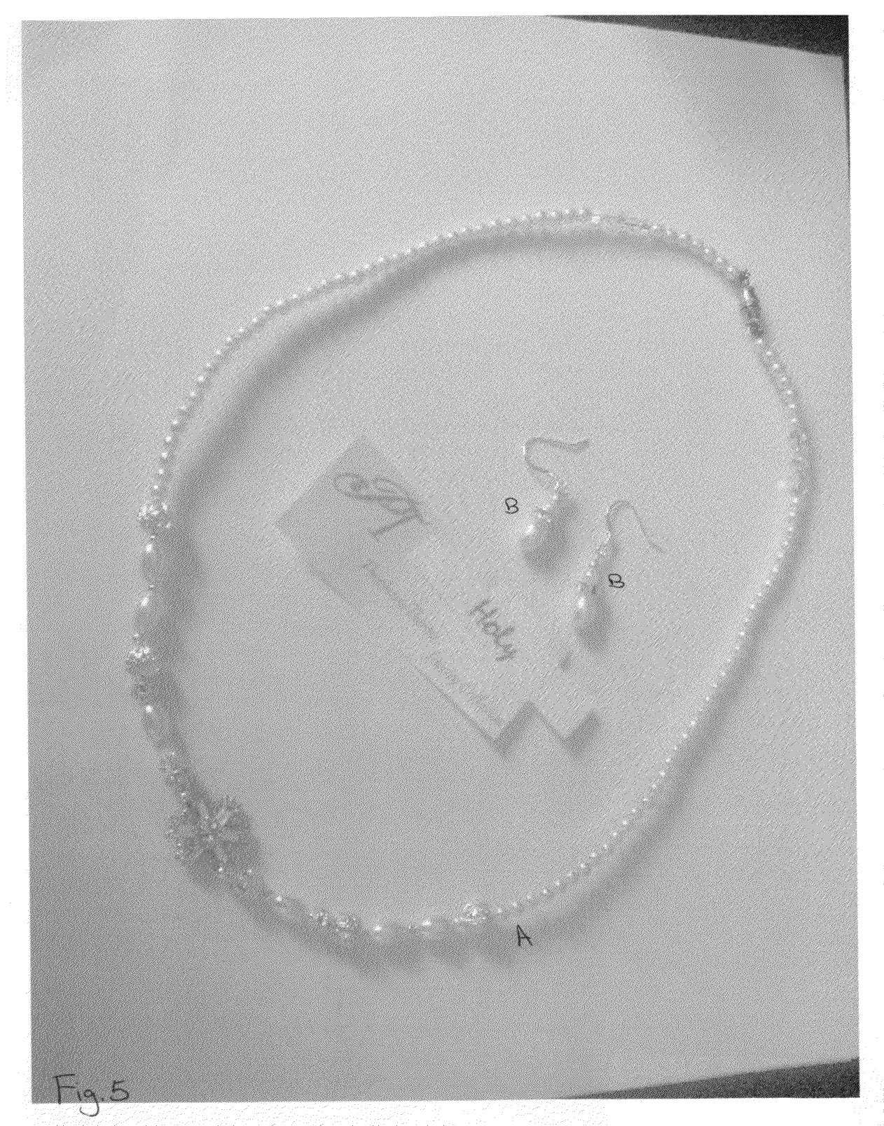

FIG. 6 illustrates a uniquely designed semi precious stone necklace (A) and earrings (B) in black, clear, silver, and purple stones and beads showcasing a cross; this set is entitled Peace Maker.

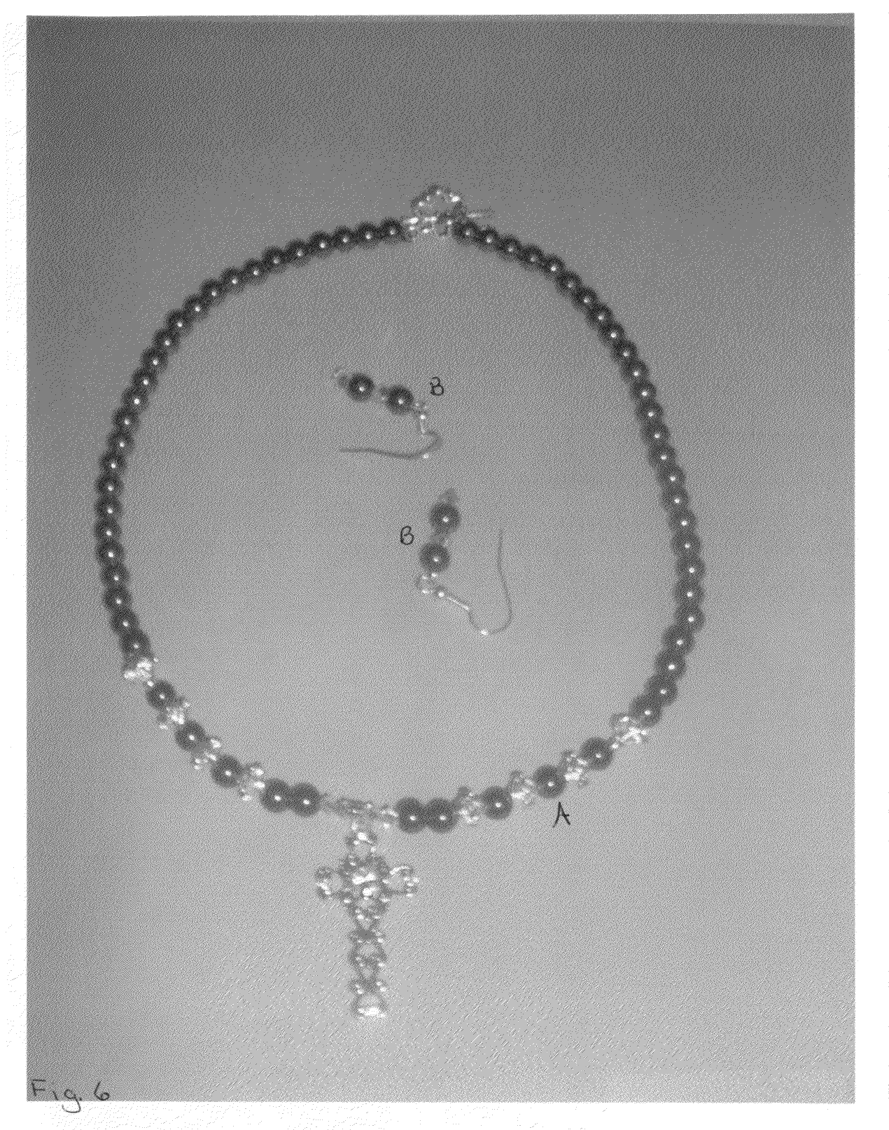

FIG. 7 illustrates a uniquely designed semi precious stone necklace (A) and earrings (B) in black, silver and clear showcasing a heart; this set is entitled Power of Love.

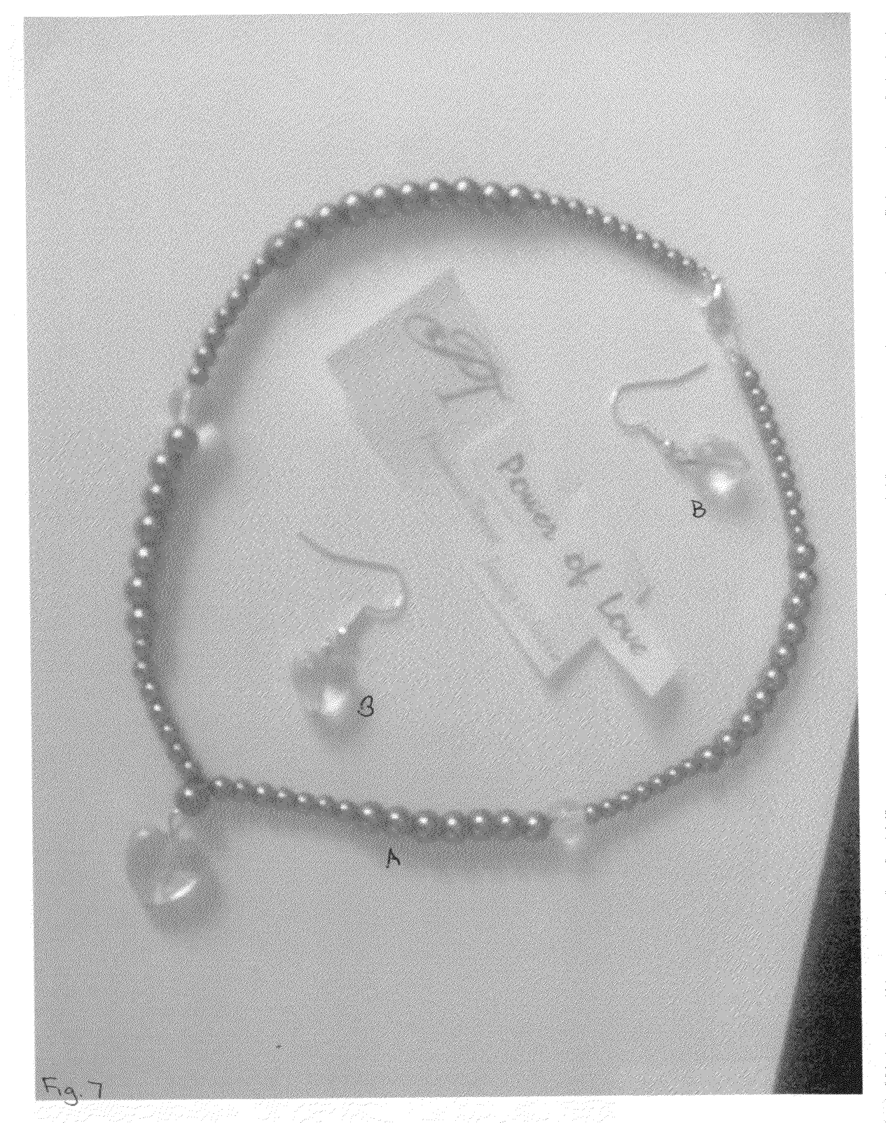

FIG. 8 illustrates a uniquely designed semi precious stone necklace (A) and earrings (B) in pink, clear, and silver beads; this set is entitled Season.

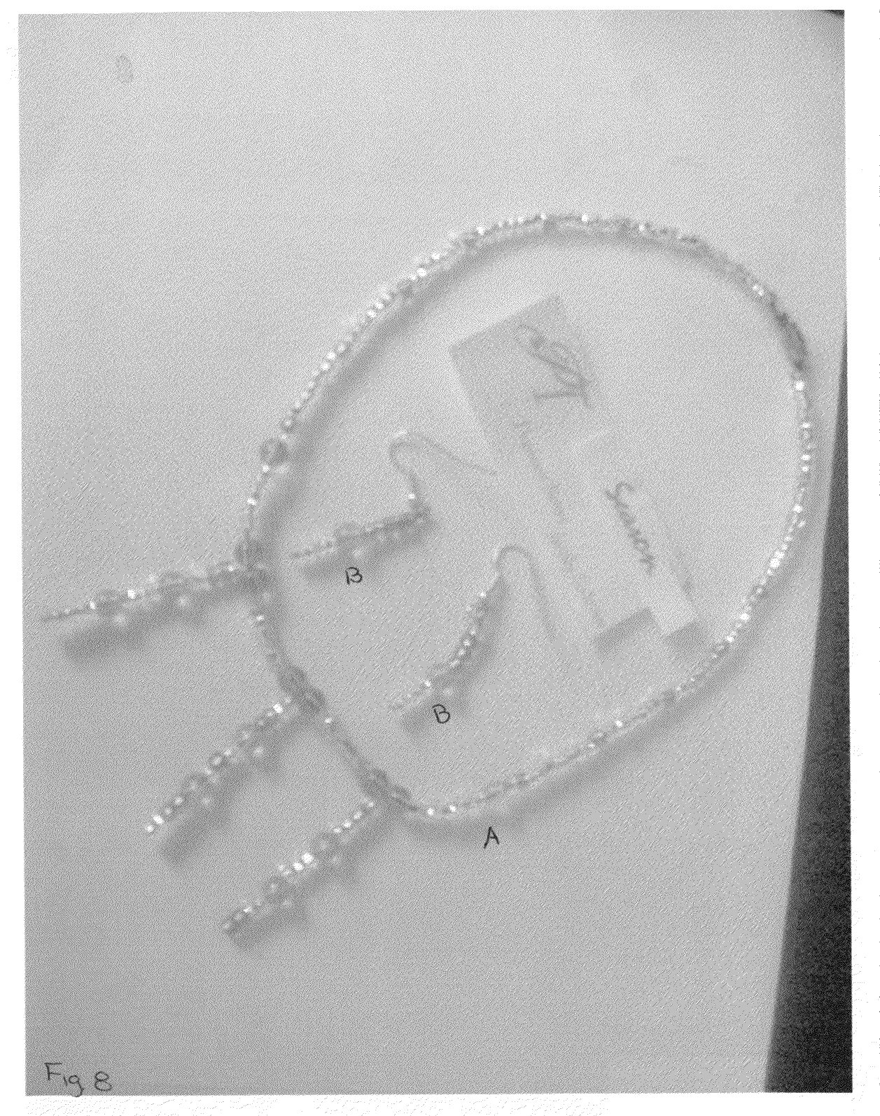

FIG. 9 illustrates a uniquely designed semi precious stone necklace (A) and earrings (B) in pink pearls and beads; this set is entitled Purification.

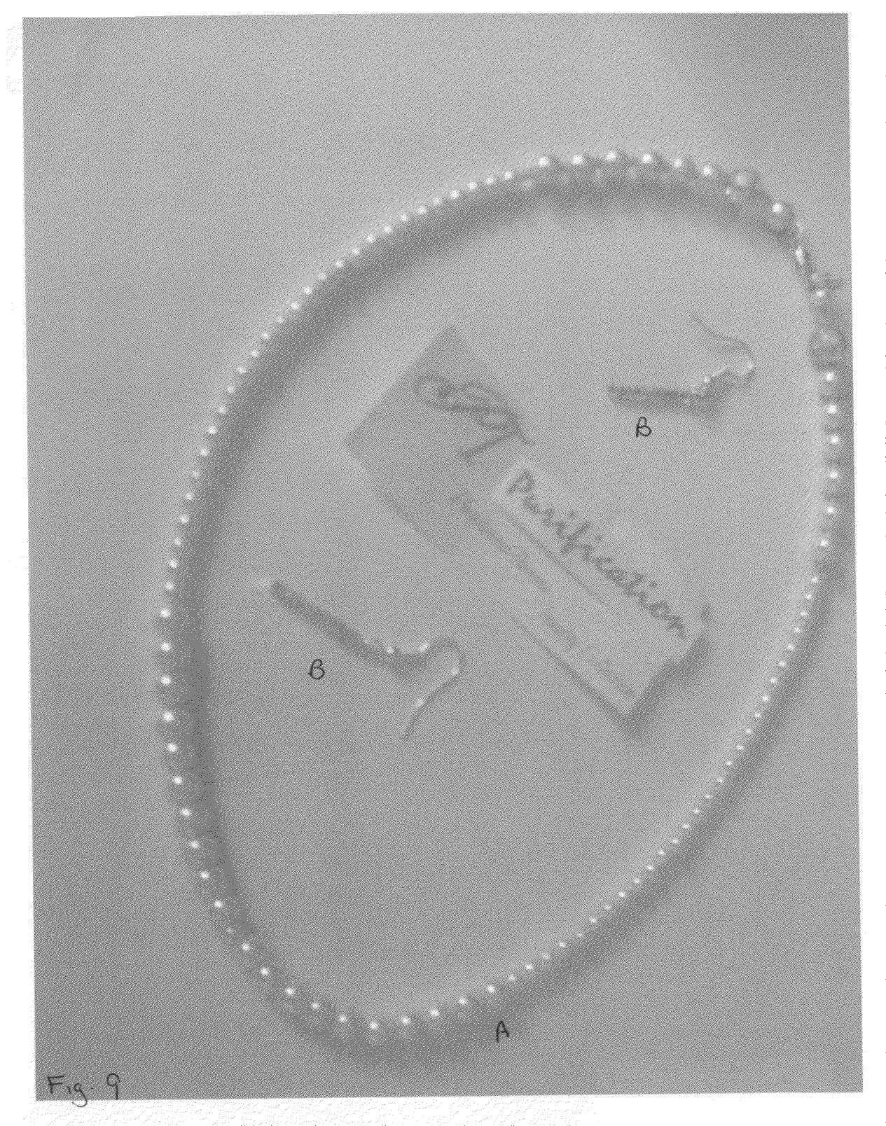

FIG. 10 illustrates a uniquely designed semi precious stone necklace (A), earrings (B) and bracelet (C) in pink and black stones and beads; this set is entitled Prosperity.

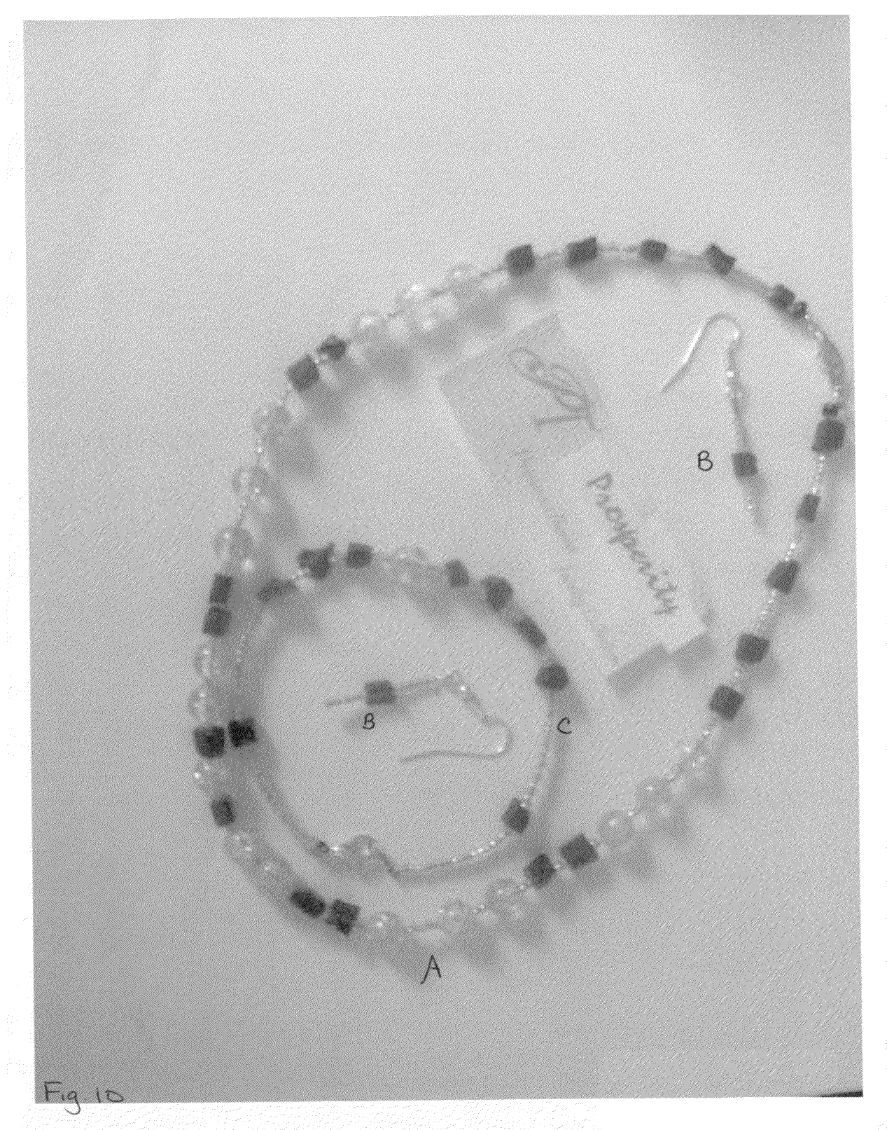

FIG. 11 illustrates a uniquely designed semi precious stone necklace (A) and earrings (B) in Aqua/Turquoise, clear and silver stone and beads; this set is entitled Fruitful.

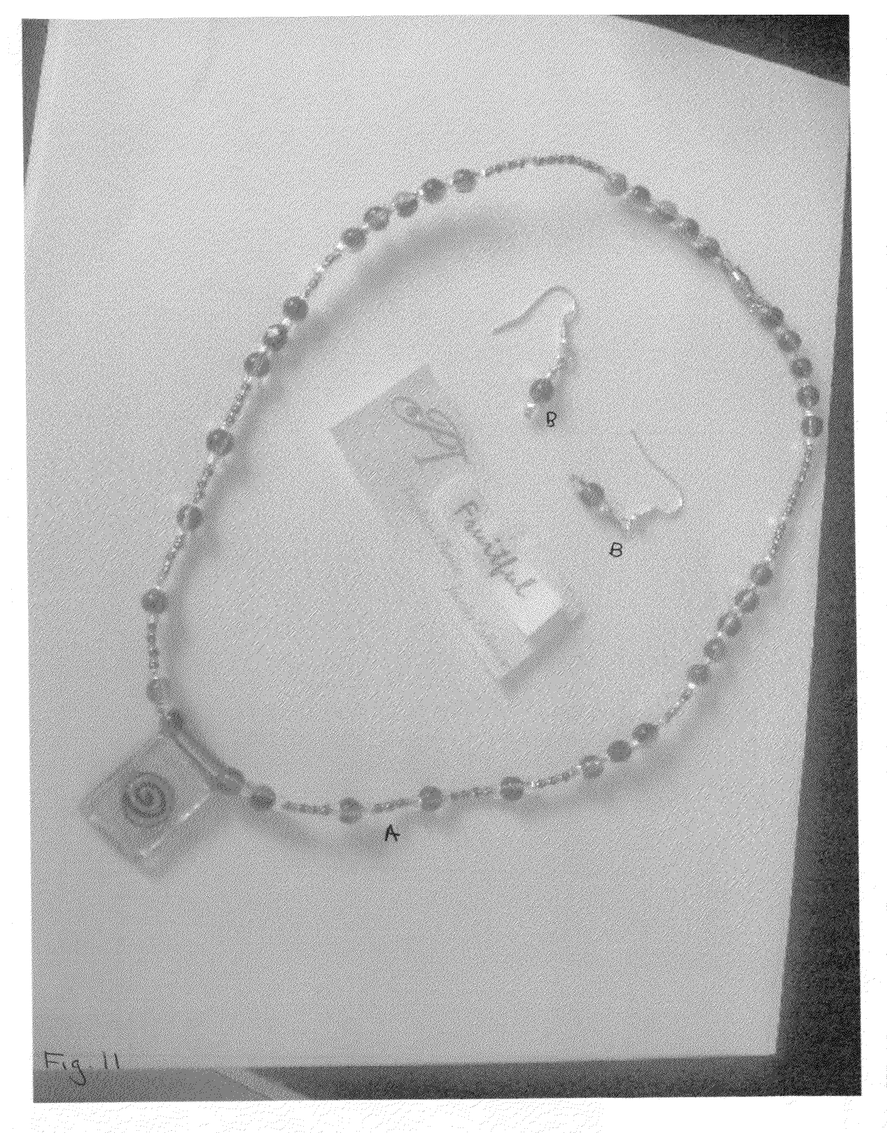

FIG. 12 illustrates a uniquely designed semi precious stone necklace (A) and earrings (B) in blue, silver, and clear beads; this set is entitled Inspire.

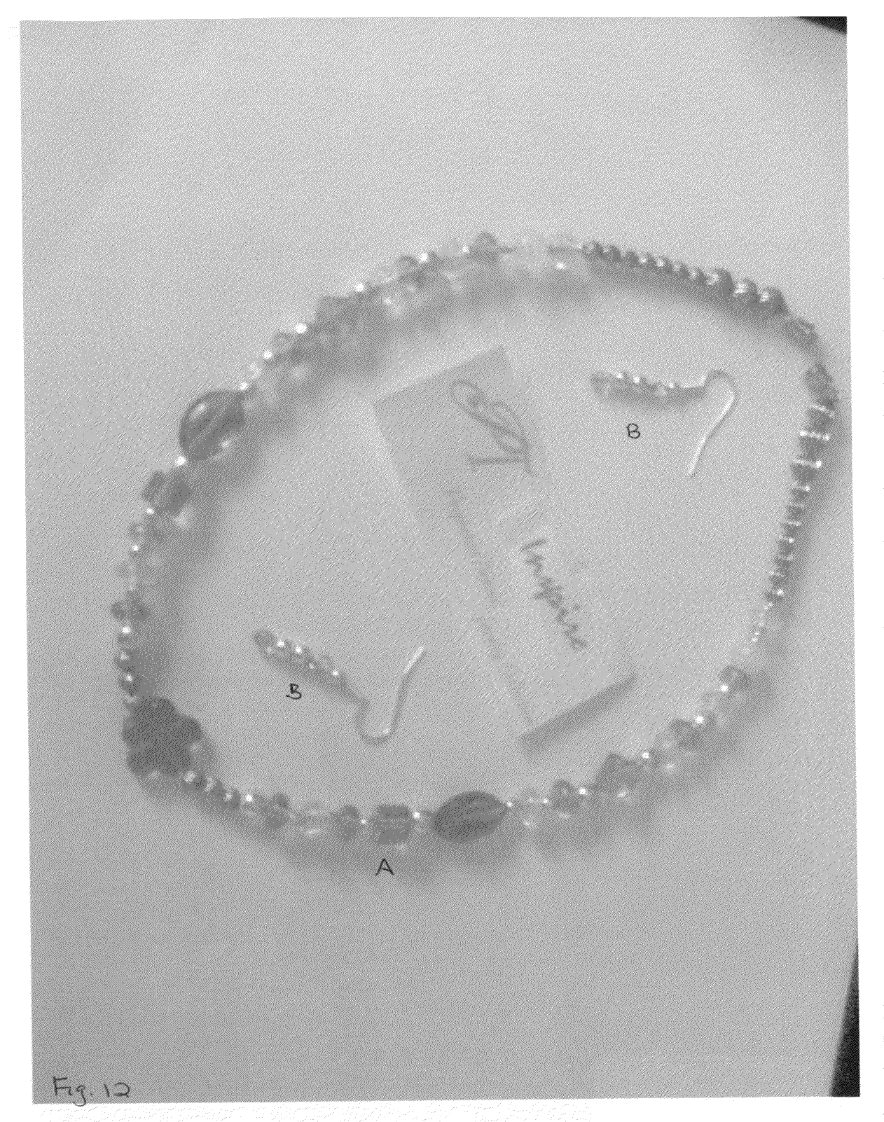

FIG. 13 illustrates a uniquely designed semi precious stone necklace (A) and earrings (B) in blue, white, and silver stones and beads; this set is entitled Hope.

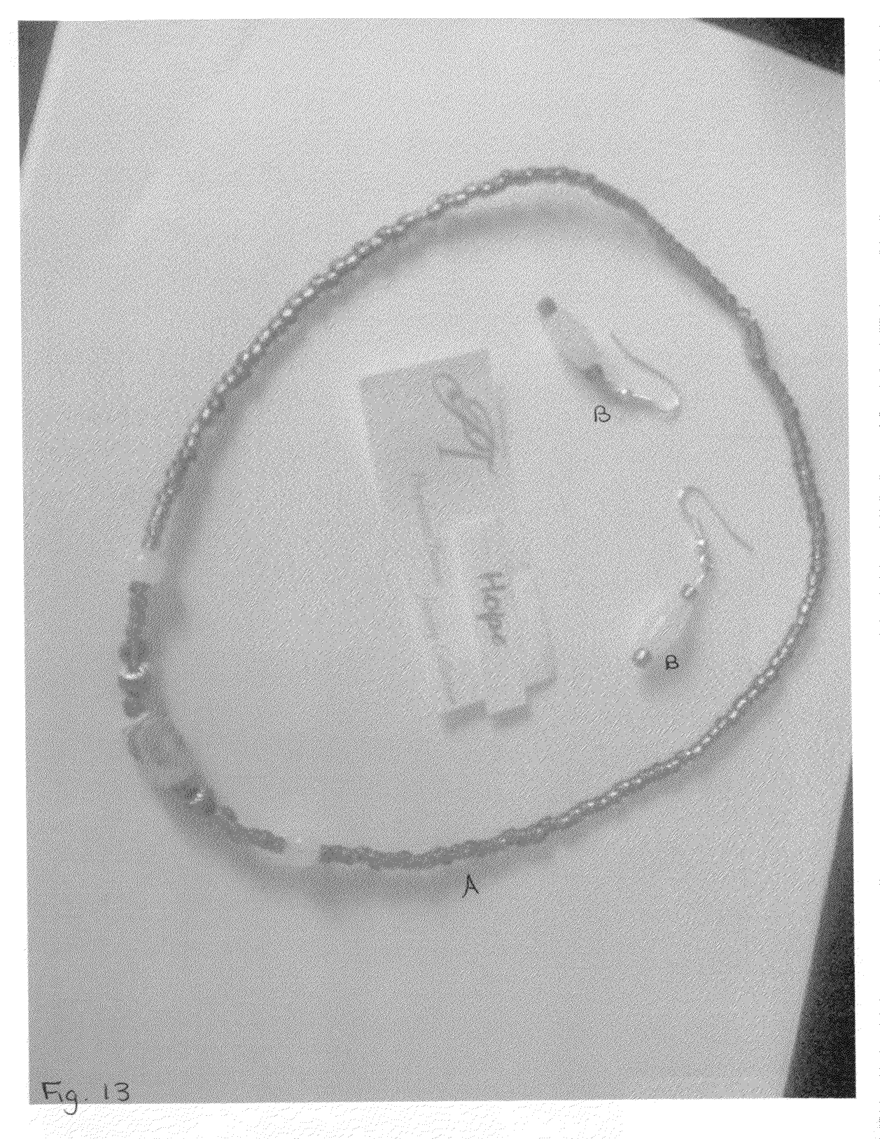

FIG. 14 illustrates a uniquely designed semi precious stone necklace (A) and earrings (B) clear black, black, and silver stones and beads; this set is entitled Faith.

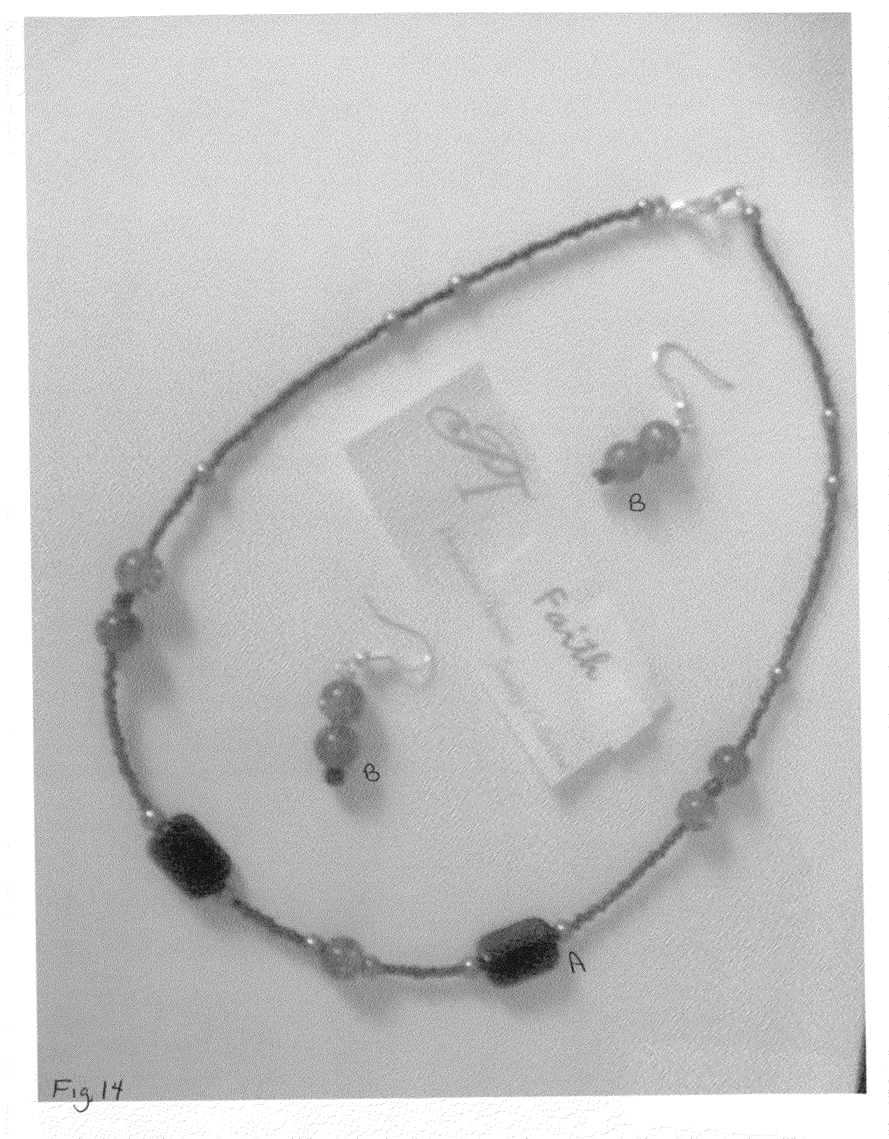

FIG. 15 illustrates a uniquely designed semi precious stone necklace (A) and earrings (B) in green and blue stones and beads; this set is entitled Crown of Compassion.

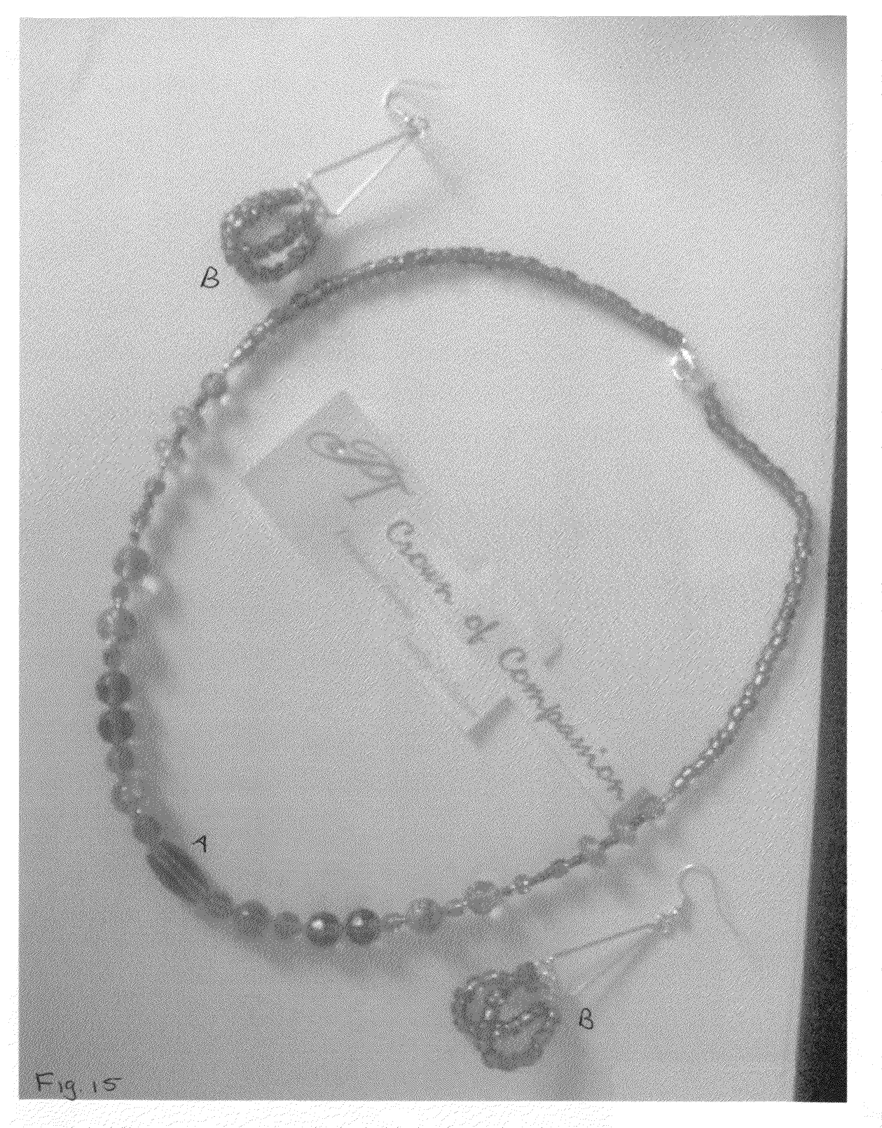

FIG. 16 illustrates a uniquely designed semi precious stone necklace (A), earrings (B) and bracelet (C) in blue and green stones and beads; this set is entitled Cool Breeze.

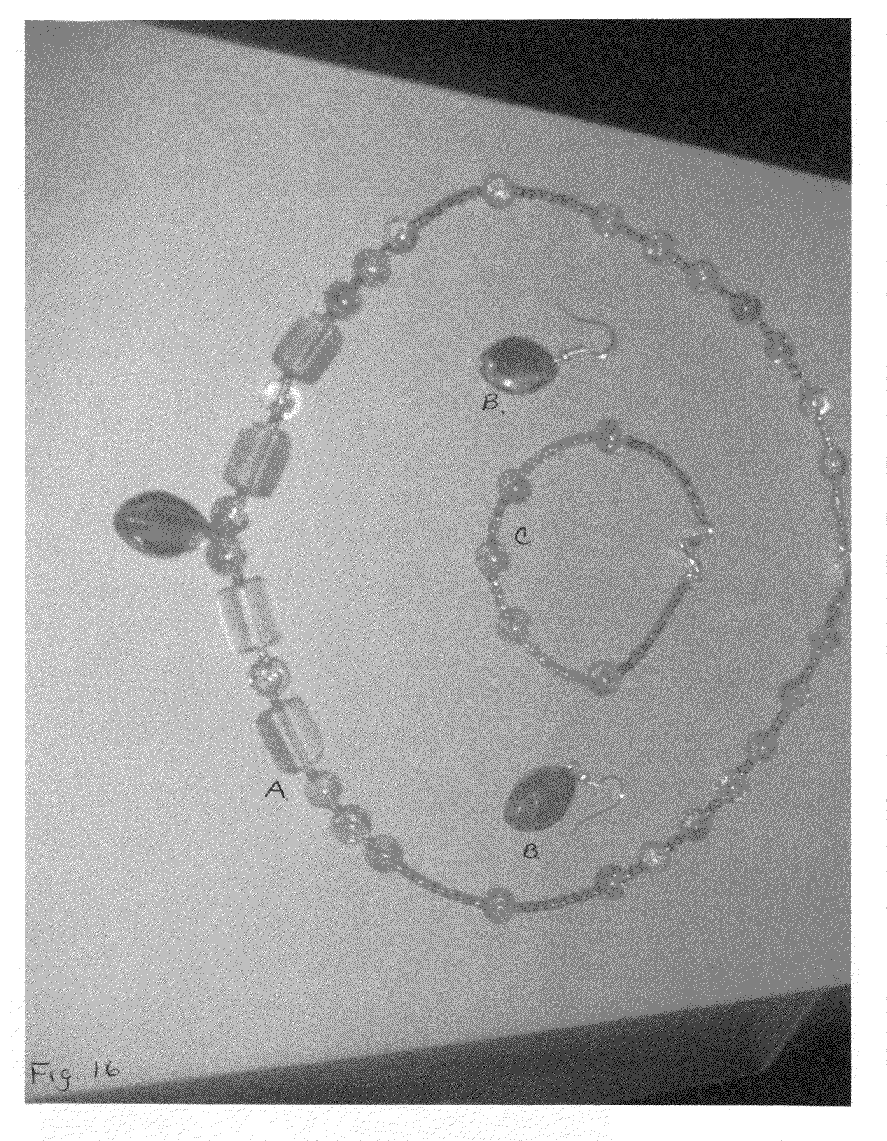

FIG. 17 illustrates a uniquely designed semi precious stone necklace (A), earrings (B) and bracelet (C) in blue stone and beads; this set is entitled Powerful.

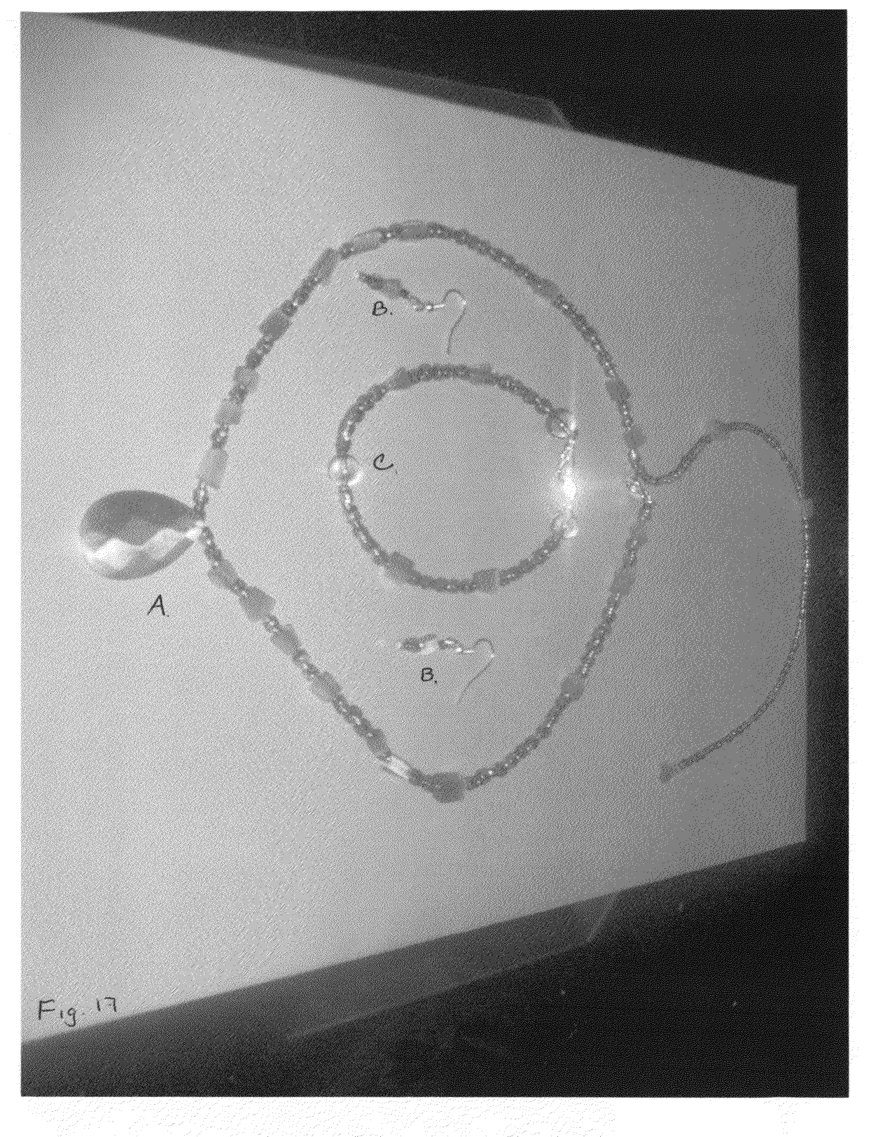

FIG. 18 illustrates a uniquely designed semi precious stone necklace (A), earrings (B) and bracelet (C) in brown, orange and white stones and beads; this set is entitled Bethany.

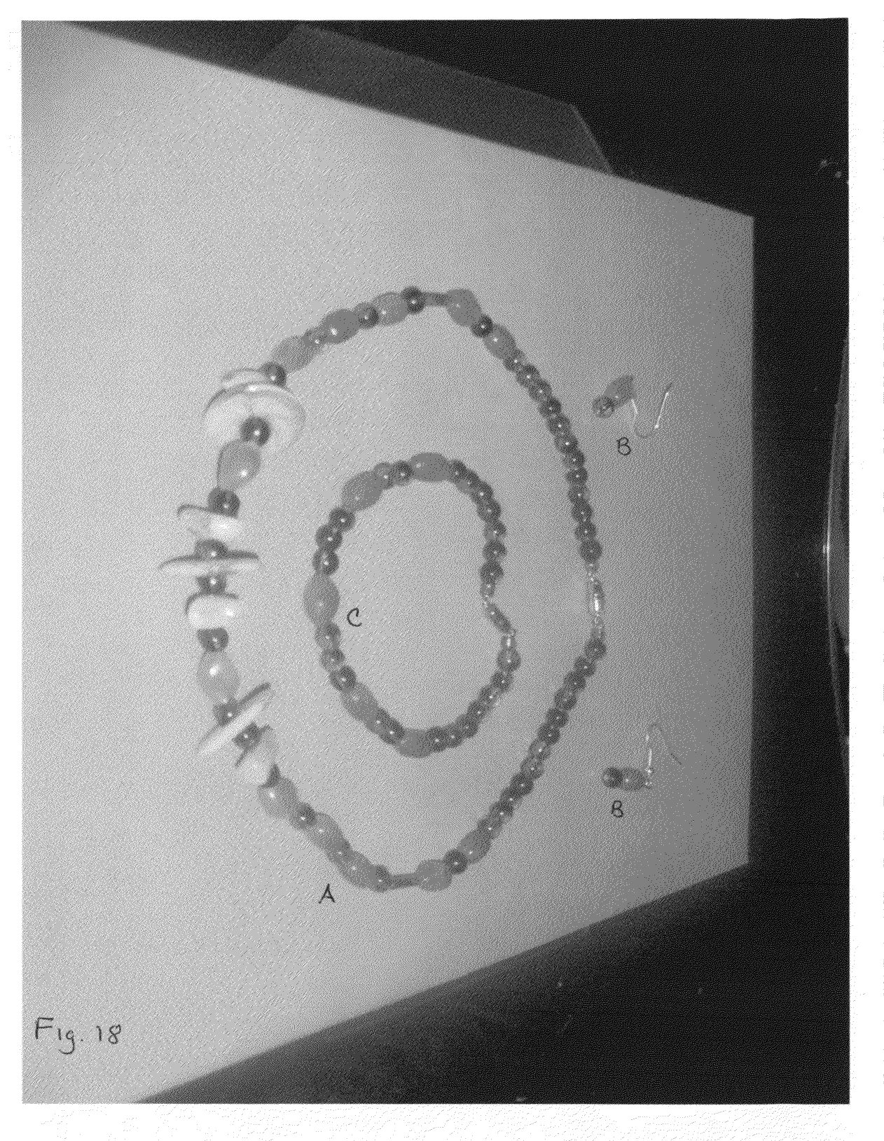

FIG. 19 illustrates a uniquely designed semi precious stone necklace (A), earrings (B) and bracelet (C) in brown, silver, clear, black, and gold stone and beads; this set is entitled Royalty.

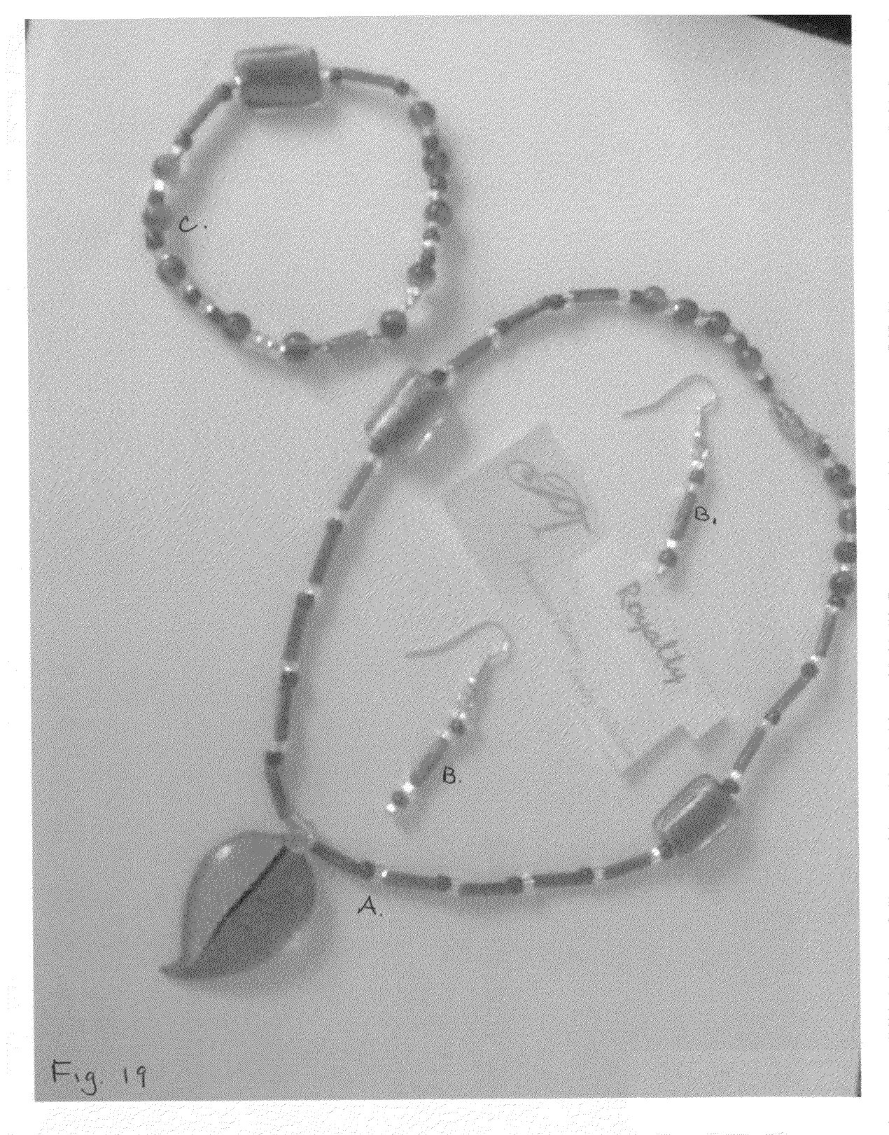

FIG. 20 illustrates a uniquely designed semi precious stone necklace (A), earrings (B) and bracelet (C) in black, white, and silver beads and stone; this set is entitled Maturity.

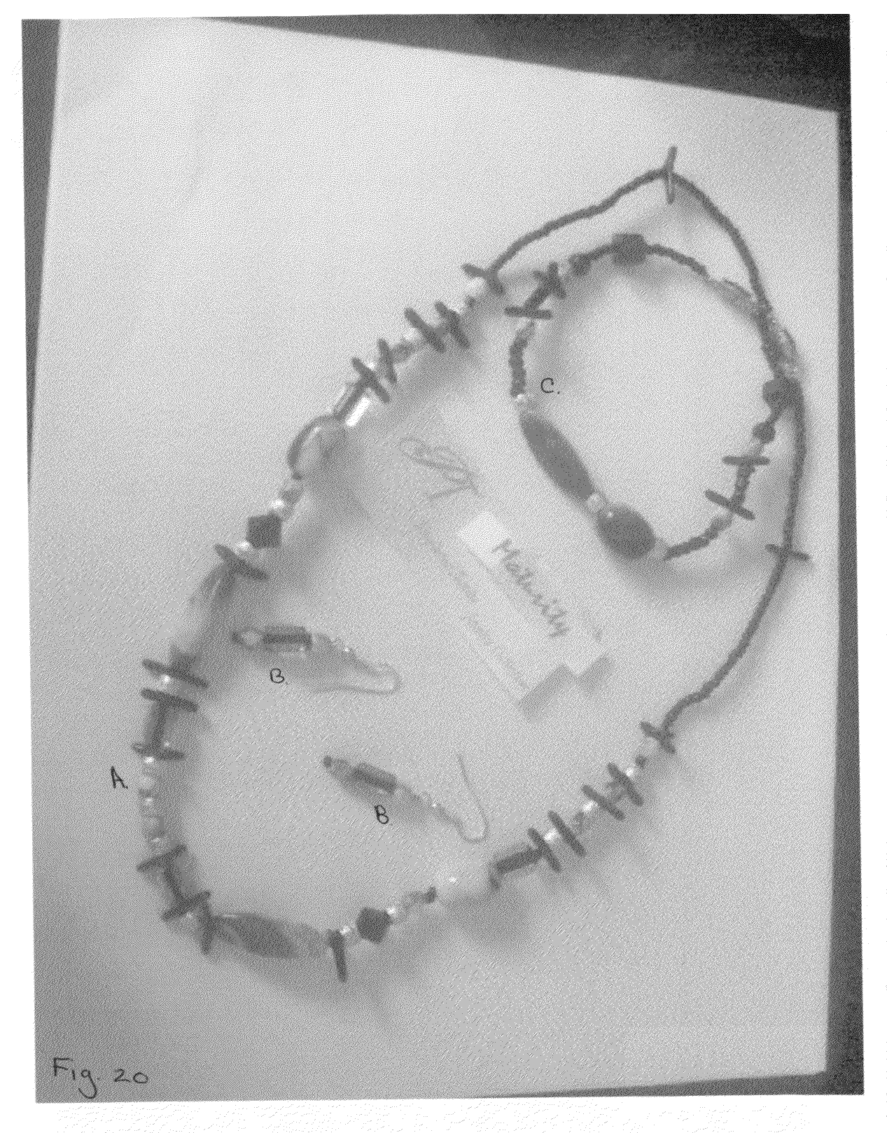

FIG. 21 illustrates a uniquely designed semi precious stone necklace (A), earrings (B) and bracelet (C) in yellow and brown stone and beads; this set is entitled Rainbow.

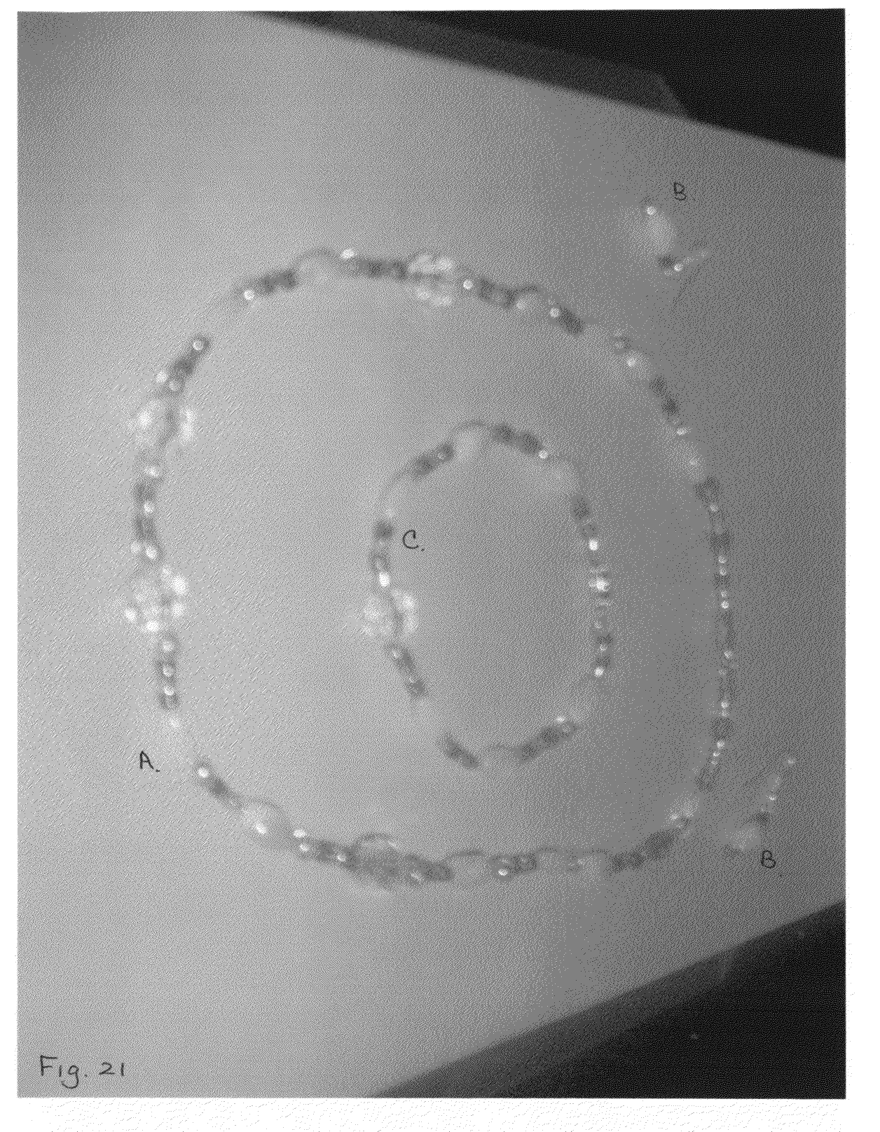

1. A method comprising: designing an article of jewelry having uniformity, color, and semi-precious stones; lengthen or shorten an article of jewelry having color and semi-precious stones according to the consumer's input at a retail location; imaging the article of jewelry at the retail location; pricing the article of jewelry; and obtaining a commitment to purchase the article of jewelry.

2. The method of claim 1 where designing the article of jewelry includes selecting from one of the 21 styles designed by Prophetess Theresa.

3. The method of claim 1 where imaging the article of jewelry includes providing a hard copy having an image of the article of jewelry.

4. The method of claim 1 comprising enabling the jewelry designs to be modified by shorting or lengthen by the consumers.

5. The method of claim 1 where obtaining a commitment includes obtaining a consumer's commitment to purchase the article of jewelry from a retailer.

6. The method of claim 5 where obtaining a commitment includes obtaining a retailer's commitment to purchase the article of jewelry from a manufacturer.
